(19) United States
(12) Patent Application Publication
(10) Pub. No.: US 2016/0183145 A1
(43) Pub. Date: Jun. 23, 2016

(54) Seamless Antenna Hanover System and Related Methods for Non-Geosynchronous Satellites

(71) Applicant: Comtech EF Data Corp., Tempe, AZ (US)

(72) Inventors: Lakshmana Chintada, Chandler, AZ (US); Jeffrey Harig, Mesa, AZ (US)

(21) Appl. No.: 14/596,981

(22) Filed: Jan. 14, 2015

Related U.S. Application Data
(63) Continuation of application No. 14/154,512, filed on Jan. 14, 2014, now abandoned.
(60) Provisional application No. 61/752,105, filed on Jan. 14, 2013.

(51) Int. Cl. H04W 36/18; H04W 56/00

(52) U.S. Cl. CPC H04W 36/18; H04W 56/004; H04W 84/06

(57) ABSTRACT

A method of seamless antenna handover comprising transmitting at least one of a handover trigger packet and a handover synchronization packet (HSP) by a transmitter to a first and a second repeating relay, the first repeating relay configured to transmit a data signal to a first modem at a remote receiver and the second repeating relay configured to transmit the data signal to a second modem at the remote receiver, receiving, by the first and second modems at the remote receiver, the data signal and the at least one of the handover trigger packet and the HSP from the first and second repeating relays, respectively, and activating one of the first and second modems and deactivating the other of the first and second modems in response to receiving the at least one of the handover trigger packet and the HSP.

### CROSS REFERENCE TO RELATED APPLICATIONS

This document is a continuation of earlier U.S. patent application Ser. No. 14/154,512, entitled “Seamless Antenna Handover System and Related Methods for Non-Geosynchronous Satellites” to Lakshmana Chintada et al., filed on Jan. 14, 2014, now pending, which application claims the benefit of the filing date of U.S. Provisional Patent Application No. 61/752,105, entitled “Seamless Antenna Handover System and Related Methods for Non-Geosynchronous Satellites” to Lakshmana Chintada et al., which was filed on Jan. 14, 2013, the disclosures of which are hereby incorporated entirely by reference herein.

### BACKGROUND

1. Technical Field

Aspects of this document relate generally to telecommunication systems and techniques for transmitting data across a telecommunication channel for non-geosynchronous satellites.

2. Background Art

In a telecommunication connection in which a satellite is used to establish a connection or link between two ground stations, if the satellite is not geostationary, eventually the satellite will move relative to one or both of the ground stations sufficiently far that one or more of the ground stations will no longer be able to receive signals from it. Because many ground stations contain at least two antennas oriented in different directions, maintaining the connection between the two ground stations generally requires the ground stations to utilize a second satellite oriented in a different direction, and accordingly, different antennas.

As the satellites move by, at least two antennas with one antenna control unit is required to handover between satellites. During the handover, due to communication path change, there is data packet loss and/or duplicate packets of data received by one or more ground stations. In addition to these issues, due to differential path delay between two satellites, there are also out-of-sequence packets received by the one or more ground stations.

### SUMMARY

Implementations of a method of seamless antenna handover may comprise transmitting at least one of a handover trigger packet and a handover synchronization packet (HSP) by a transmitter to a first and a second repeating relay, the first repeating relay configured to transmit a data signal to a first modem at a remote receiver and the second repeating relay configured to transmit the data signal to a second modem at the remote receiver, receiving, by the first and second modems at the remote receiver, the data signal and the at least one of the handover trigger packet and the HSP from the first and second repeating relays, respectively, and activating one of the first and second modems and deactivating the other of the first and second modems in response to receiving the at least one of the handover trigger packet and the HSP.

Particular aspects may comprise one or more of the following features. A path delay between the transmitter and the remote receiver may be shorter for the first repeating relay than the path delay between the transmitter and the remote receiver for the second repeating relay. The HSP may be received during a buffering period during the antenna handover. The transmitter may transmit the HSP across a plurality of FEC blocks. The method may further comprise transmitting a Doppler Delay Packet (DDP) by the activated modem at the remote receiver to the transmitter. The second modem may wait for a Doppler Packet Delay (DPD) duration prior to egressing data to a local area network (LAN) when the antenna handover is from the first repeating relay to the second repeating relay. The transmitter may buffer transmitted data for the duration of the Doppler Packet Delay (DPD) in response to receiving the DDP. After the data is no longer buffered by the transmitter, the first modem may egress the received data to a local area network (LAN). The antenna handover may occur without any duplicate data packets being egressed to a LAN by either of the first and second modems. The antenna handover may occur without any data packets being received out of sequence or dropped. The transmitter may comprise a first modem configured to transmit and receive a data signal and a second modem configured to receive a data signal.

Implementations of a system for seamless antenna handover may comprise a transmitter configured to transmit at least one of a handover trigger packet and a handover synchronization packet (HSP) to a first and a second repeating relay and a remote receiver comprising a first modem configured to receive a data signal transmitted by the first repeating relay and a second modem configured to receive the data signal transmitted by the second repeating relay, wherein the first and second modems are further configured to receive the at least one of the handover trigger packet and the HSP from the first and second repeating relays, respectively and activate one of the first and second modems and deactivate the other of the first and second modems in response to receiving the at least one of the handover trigger packet and the HSP.

Particular aspects may comprise one or more of the following features. A path delay between the transmitter and the remote receiver may be shorter for the first repeating relay than the path delay between the transmitter and the remote receiver for the second repeating relay. The HSP may be received during a buffering period during the antenna handover. The transmitter may be further configured to transmit the HSP across a plurality of FEC blocks. The activated modem of the remote receiver may be further configured to transmit a Doppler Delay Packet (DDP) to the transmitter. The second modem of the remote receiver may be configured to wait for a Doppler Packet Delay (DPD) duration prior to egressing data to a local area network (LAN) when the antenna handover is from the first repeating relay to the second repeating relay. The transmitter may be further configured to buffer transmitted data for the duration of the Doppler Packet Delay (DPD) in response to receiving the DDP. The first modem of the remote receiver may be further configured to egress the received data to a local area network (LAN) after the data is no longer buffered by the transmitter. The antenna handover may occur without any duplicate data packets being egressed to a LAN by either of the first and second modems. The antenna handover may occur without any data packets being received out of sequence or dropped. The transmitter may comprise a first modem configured to transmit and receive a data signal and a second modem configured to receive a data signal.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112(f). Thus, the use of the words “function,” “means” or “step” in the Description , Drawings, or Claims is not intended to somehow indicate a desire to invoke the special provisions of 35 U.S.C. §112(f), to define the invention. To the contrary, if the provisions of 35 U.S.C. §112(f) are sought to be invoked to define the claimed disclosure, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112(f). Moreover, even if the provisions of 35 U.S.C. §112(f) are invoked to define the claimed disclosure, it is intended that the disclosure not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIGS. 1A-B provide examples of embodiments of an antenna handover system.

FIGS. 2A-B provide examples of a long path delay to short path delay antenna handover gateway to a remote receive data stream solution.

FIG. 3 provides an example of a short path delay to long path delay antenna handover gateway to remote receive data stream solution.

FIGS. 4A-4C illustrate examples of a remote to gateway data stream of a long delay path to short delay path antenna handover and a delay to non-delay antenna handover.

FIG. 5 provides an example of an antenna handover trigger packet.

FIG. 6A provides an example of the prior art in which handovers between delay and non-delay modems result in packet loss.

FIG. 6B provides an example of an implementation of the disclosed method in which handovers between delay and non-delay modems do not result in packet loss.

FIG. 7 provides a block diagram of an exemplary method of seamless antenna handover.

### DESCRIPTION

This disclosure, its aspects and implementations, are not limited to the specific components, frequency examples, communication media, or methods disclosed herein. Many additional components and assembly procedures known in the art consistent with seamless antenna handover system and related methods for non-geosynchronous satellites are in use with particular implementations from this disclosure. Accordingly, for example, although particular implementations are disclosed, such implementations and implementing components may comprise any components, models, versions, quantities, and/or the like as is known in the art for such systems and implementing components, consistent with the intended operation.

In a telecommunication connection where a satellite is used to establish a connection or link between two ground stations, if the satellite is not geostationary, eventually the satellite will move relative to one or both of the ground stations sufficiently far that one or more of the ground stations will no longer be able to receive signals from it. Because many ground stations contain at least two antennas oriented in different directions, maintaining the connection between the two ground stations will generally require the ground stations to utilize a second satellite oriented in a different direction, and accordingly, different antennas.

As non-geostationary satellites move by each other, at least two antennas per antenna control unit gateway or ground station are used to handover between satellites. During the handover, due to communication path change, there is typically packet loss and duplicate packets occurring, which is an undesirable condition. In addition to these issues, differential path delay between the two satellites results in will be out-of-sequence packets.

To obtain a seamless handover, transmitters and receivers eliminate packet loss, keep packets in sequence, and avoid complete duplicate packets. If these conditions are not met,

Internet protocols that are sensitive to packet loss or out-of-order packets will time out or slow down data transfer, thereby creating a problematic handover. Mitigating all issues during the handover when using commercial off-the-shelf (COTS) modems while not imposing extra bandwidth requirements, and not requiring modifications to existing WAN protocols such as HDLC, DVB-S, DVB-S2, or other known protocols, is challenging. Implementations of the systems and methods described herein may provide a handover having no packet loss, no out-of-order packets, and minimal duplicate packets without imposing any additional bandwidth requirements, requiring any modifications to WAN protocols such as HDLC, DVB-S, DVB-S2, etc., and most importantly without any custom-built equipment either at the ground station or remote stations.

Based on remote stations' geographical locations, the remote stations may be required to switch from a long-delay-path satellite to short-delay-path, or short-delay-path to long-delay-path satellite or other repeating relay. Throughout the remainder of this disclosure, the terms satellite and repeating relay are intended to be used interchangeably. Implementations of the systems and methods disclosed herein may provide the solution to both long-path satellite to short-path satellite handover and short-path to long-path satellites handover.

Particular implementations of antenna handover systems and related methods may be used for satellite communications in networks where multiple satellites are being tracked and handover between antennas is required and there is a non-zero differential path delay between satellites with respect to a ground station.

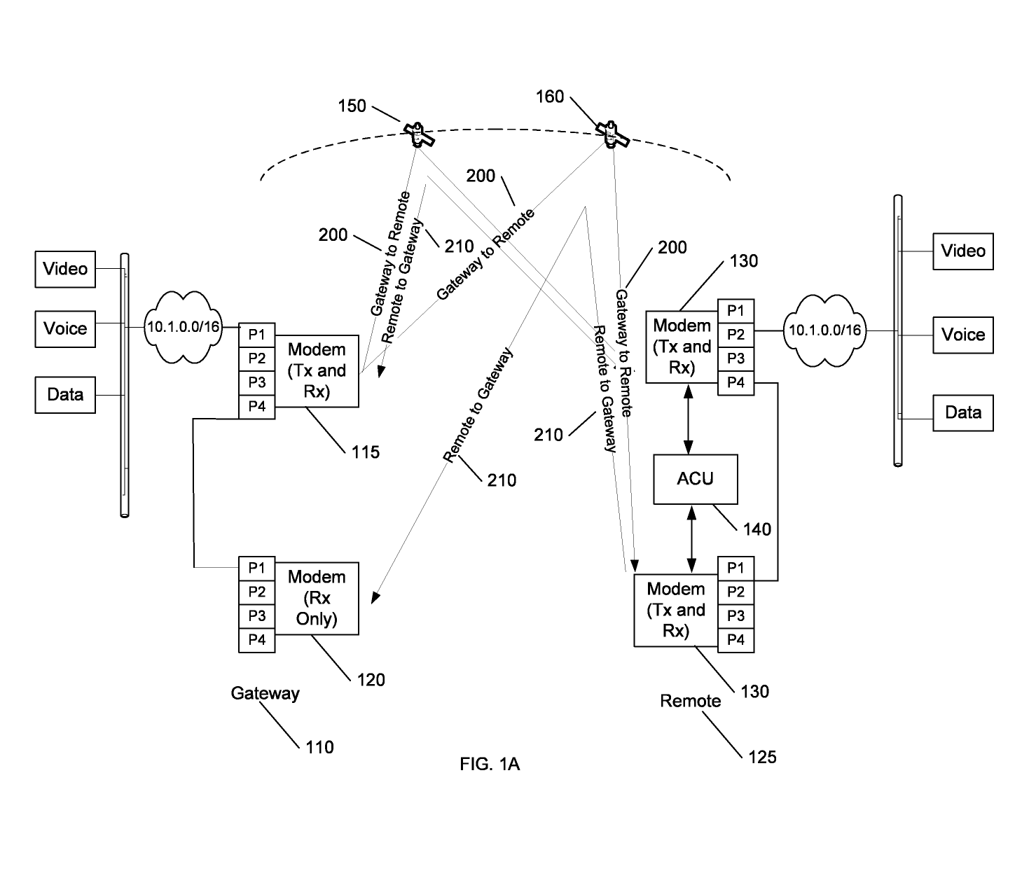

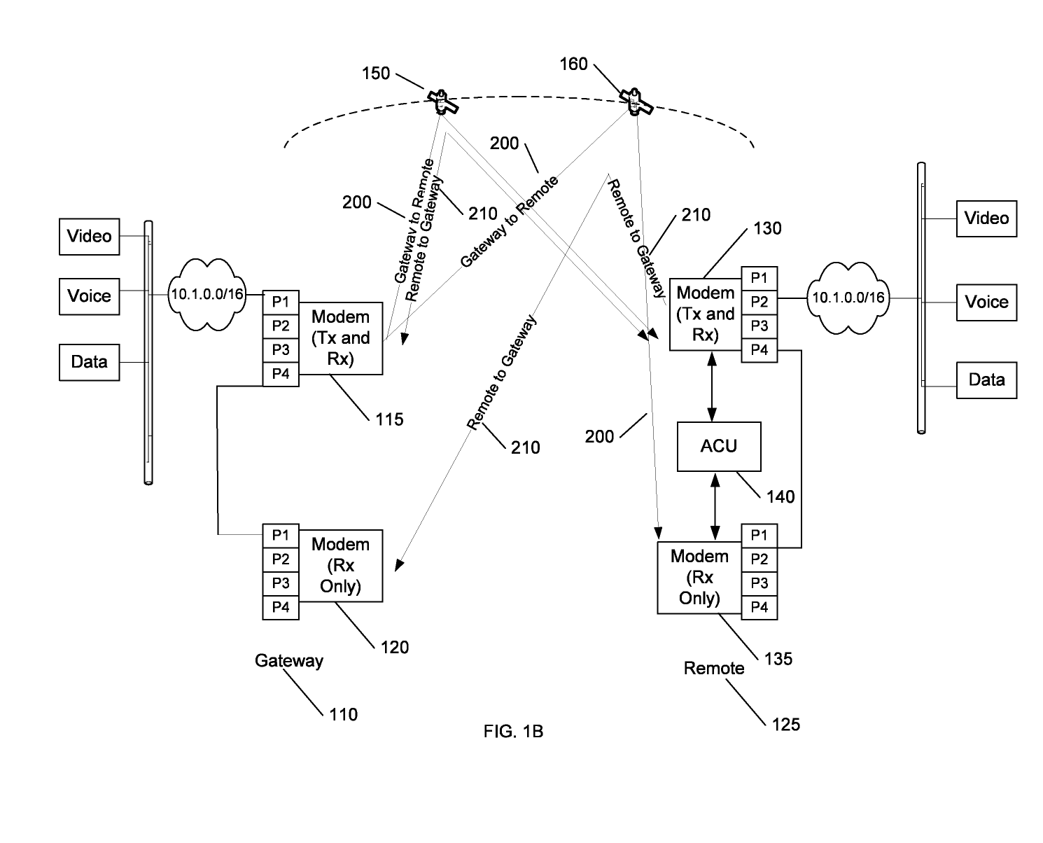

Two examples of such communication architectures are illustrated in FIGS. 1A and 1B. As shown in FIG. 1A, the gateway station (GW) 110 may comprise two modems 115, 120 such as for example, COTS modems: one with both transmit (TX) and receive (RX) capabilities enabled 115; and the other one with receive (RX) only enabled 120. The remote station 125 may comprise two modems 130 both with transmit and receive capabilities enabled 130. The Antenna Control Unit (ACU) 140, which may be a commercial off the shelf (COTS) ACU may be coupled to the remote station modems 130 to provide the antenna handover trigger signal. As shown in FIG. 1B, the gateway 110 may comprise two modems 115, 120: one with both transmit and receive capabilities enabled 115; and the other one with only receive capability enabled 120. The remote station 125 may comprise two modems 130, 135: one with both transmit and receive capabilities enabled 130; and the other one with receive only enabled 135. The ACU 140 may be coupled to the remote station modems 130, 135 to provide the antenna handover trigger signal. It should be noted that other possible configurations may be used such as for example, one modem with only transmit capabilities and a second modem with both transmit and receive capabilities at the remote receiver and one transmit and receive modem at the gateway along with one receive-only modem at the gateway. Such a configuration may allow commercial off the shelf (COTS) modem hardware to be used to avoid the need for custom-built hardware.

In some implementations, it is also not necessary for either both transmit modems, both receive modems, or both a transmitter and receiver on the same module to be operational. This allows the overall systems and methods disclosed herein to be scalable to any number of tracking antennas.

Each of the implementations of FIGS. 1A-B provide seamless handover with no packet drops, no out of sequence packets and zero duplicate packets. In the implementation of FIG. 1A, there is no special RF switching with two transmitters 130 at the remote station 125. The gateway transmitting modem signal 200 is received by both modems 130 at the remote station 125. Each modem 130 at the remote station 125 transmits a signal 210 to a satellite 150, 160 and the signal is received by the two separate receivers 115, 120 at the gateway station 110. In the implementation of FIG. 1B, there exists a single transmitter 115 at the gateway 110 and at the remote 125 end of the channel. This allows the network requirements to set the appropriate implementation for use.

In accordance with some implementations of the disclosed methods, at the remote station 125, the active modem actively transmits and receives to and from the line-of-sight satellite. The inactive modem does not have line of sight to this satellite, but is in tracking mode looking for the incoming satellite. Every time the incoming satellite travels within a range that provides the modem with a line of sight to the satellite, the ACU 140 sends the trigger signal to both modems at the same time. Along with the handover signal message, the ACU 140 also calculates and sends the differential path delay (DPD) between the two satellites 150, 160. Each time the handover signal is received, the active modem becomes inactive and the inactive modem becomes active. The currently active modem receives and transmits the data packets while the inactive modem receives but does not transmit the data packets and drops all received data packets.

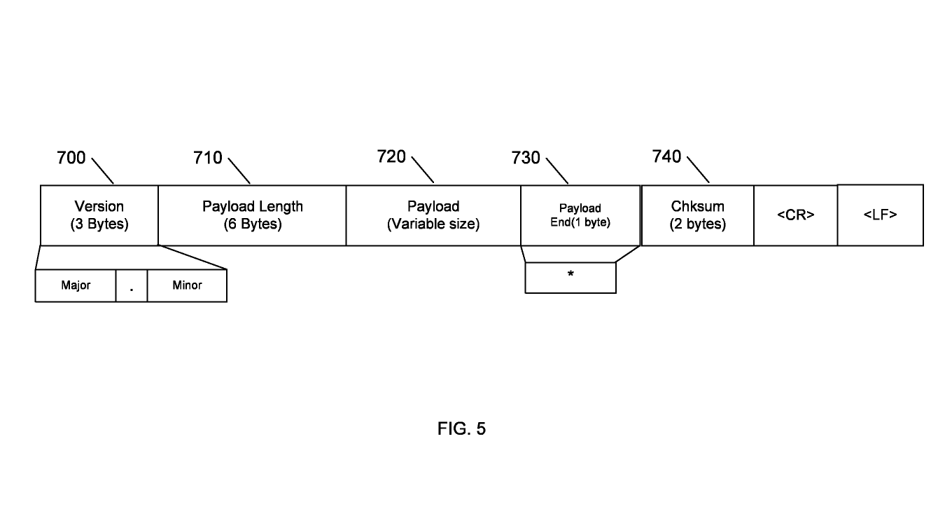

FIG. 5 provides an example of a handover trigger packet as generated by the ACU. While it is contemplated that such a handover trigger packet may comprise any relevant configuration and/or data, as shown in this example, the packet may comprise version information 700, which may be any number of bytes, but is shown here as comprising three bytes. The version information 700 may be followed by in indicator of payload length 710, which may comprise any number of bytes, but is shown in this example as comprising six bytes. The handover trigger packet also contains a payload 720 which may be of any appropriate size, followed by a one-byte indicator that of the payload end 730 and an optional checksum 740.

During the handover, both antennas may be active for a configurable amount of time. Both the modems at the remote station 125 and gateway stations 110 may be connected in a daisy chain or other configuration to make a data packet available at both modems at the same time. Upon receiving the antenna-handover trigger from the ACU 140, the respective modems at the remote stations may identify two parameters. First, one or more of the modems may identify whether a switch is being made from a long-path delay to short-path delay satellite or from a short-path delay to long-path delay satellite. Second, a differential delay between the two satellite paths may be determined.

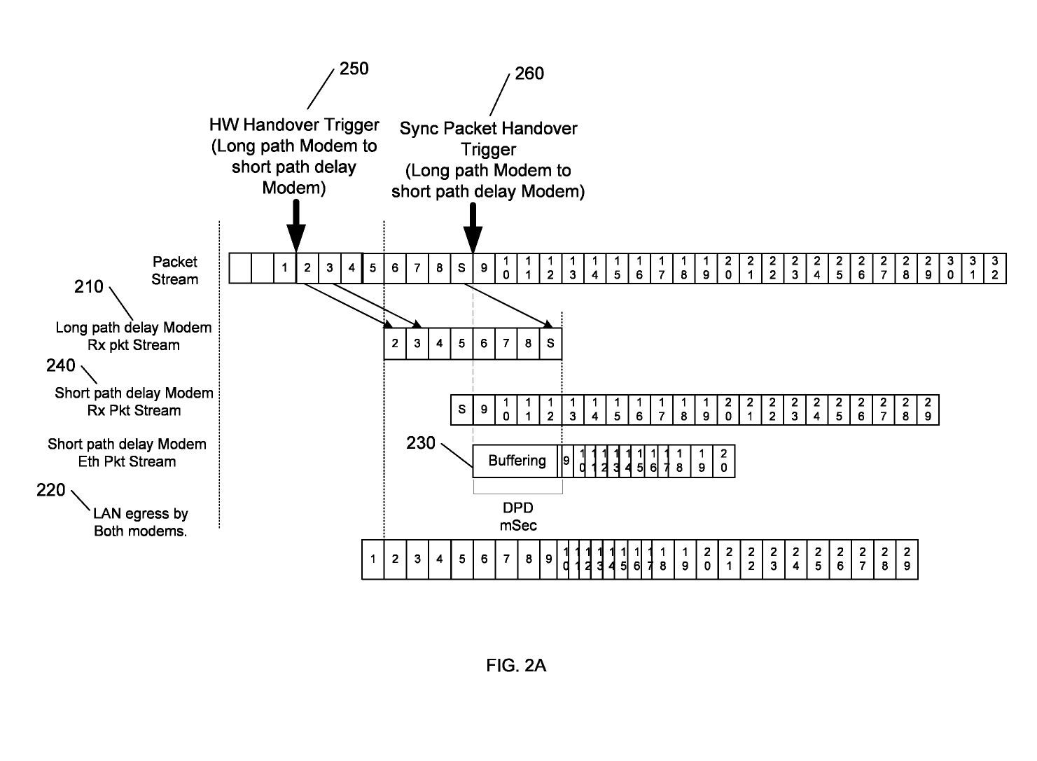

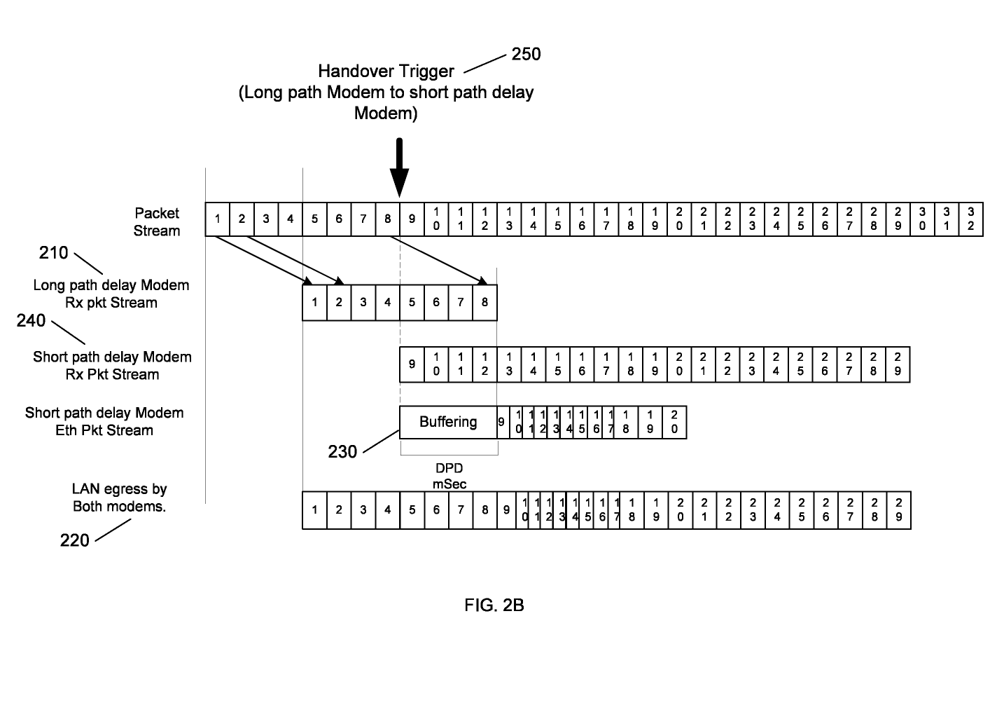

Examples of data traffic from a handover gateway station 110 to a remote station 125 during a switch from a long-path delay satellite to a short-path delay satellite are depicted in FIGS. 2A-B. As illustrated in FIG. 2B, just before the antenna handover trigger, the long-path-delay modem is active, so it receives the data packets 210 from gateway and egresses to the Local Area Network (LAN) interface 220. Upon receiving the antenna handover trigger message, the receive path still is kept active for the DPD time 230. Also, just before the antenna handover trigger, the short path delay modem is inactive, so it receives the packets, but drops them at the modem and does not egress them to the LAN. Upon receiving the antenna handover trigger, the receive path becomes active immediately 240. At this point, since both modems are receiving traffic at the same time, if they both were to send all of the packets, there would be out-of-sequence packets and duplicate packets. Hence, the short-path-delay modem must buffer for a “Doppler Packet Delay” (DPD) time 230 while waiting for long-path-delay packets to be received. After the buffering time 230, the short-path-delay modem egresses on the LAN 220 at LAN-negotiated speed. FIG. 2A provides an example of an implementation in which the handover trigger packet 250 is received prior to a handover synchronization packet (HSP) 260 in which buffering occurs during the DPD time 230 in response to receipt of the HSP 260.

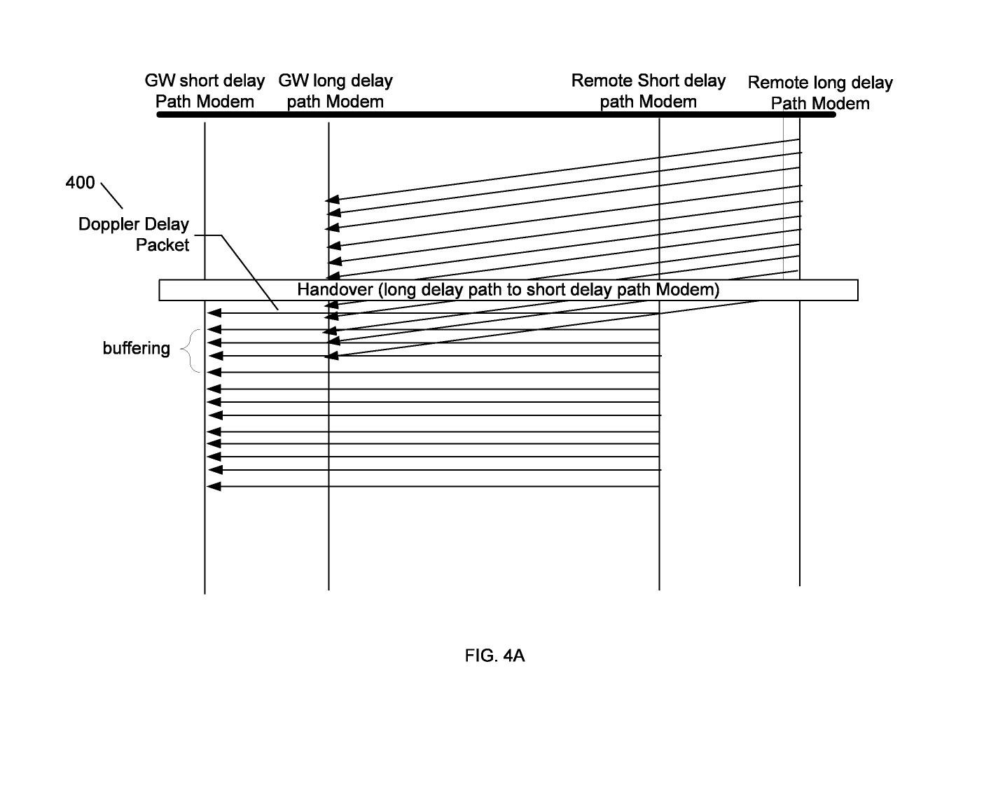

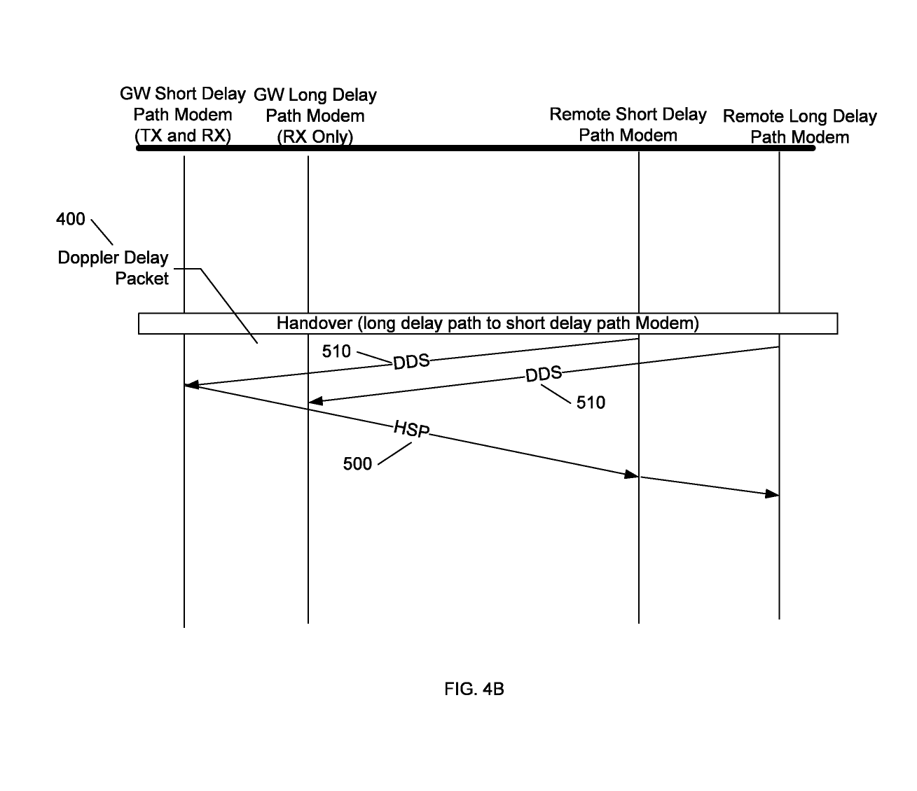

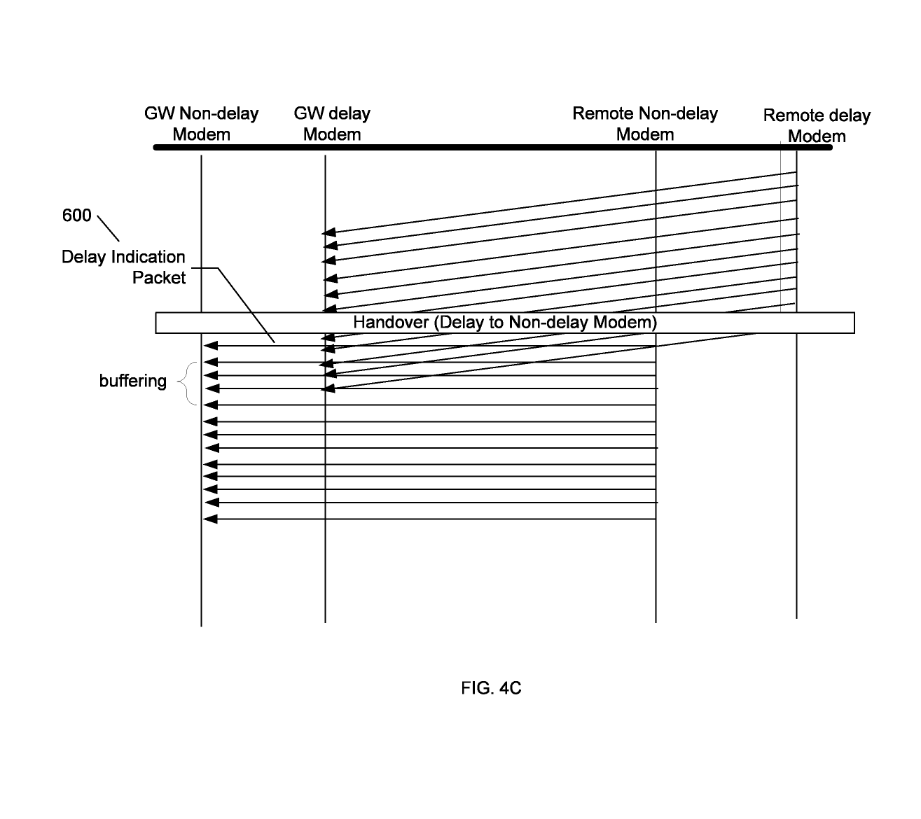

FIGS. 4A-B provide an example of data traffic flowing from remote gateway stations during a switch from a long-path delay satellite to a short-path delay satellite. As illustrated, just before antenna handover triggers, the long-path-delay modem is active, so it transmits the packets from remote 125 to gateway 110. Upon receiving the antenna handover trigger message 250, the transmit path will become inactive. Hence, no packets will be transmitted to the gateway 110 by long-path-delay modem. Also, just before the antenna handover trigger, the short-path-delay modem is inactive and not transmitting any packets. Upon receiving the antenna handover trigger, the transmit path becomes active immediately and sends a “Doppler Delay Packet” (DDP) 400 to the receiver at the gateway station 110. Upon receiving the DDP 400 at the gateway modem, the gateway modem buffers the traffic for the amount of time (DPD) 230 indicated in the DDP 400. After the timeout, the modem egresses the traffic on the LAN at the LAN-negotiated speed.

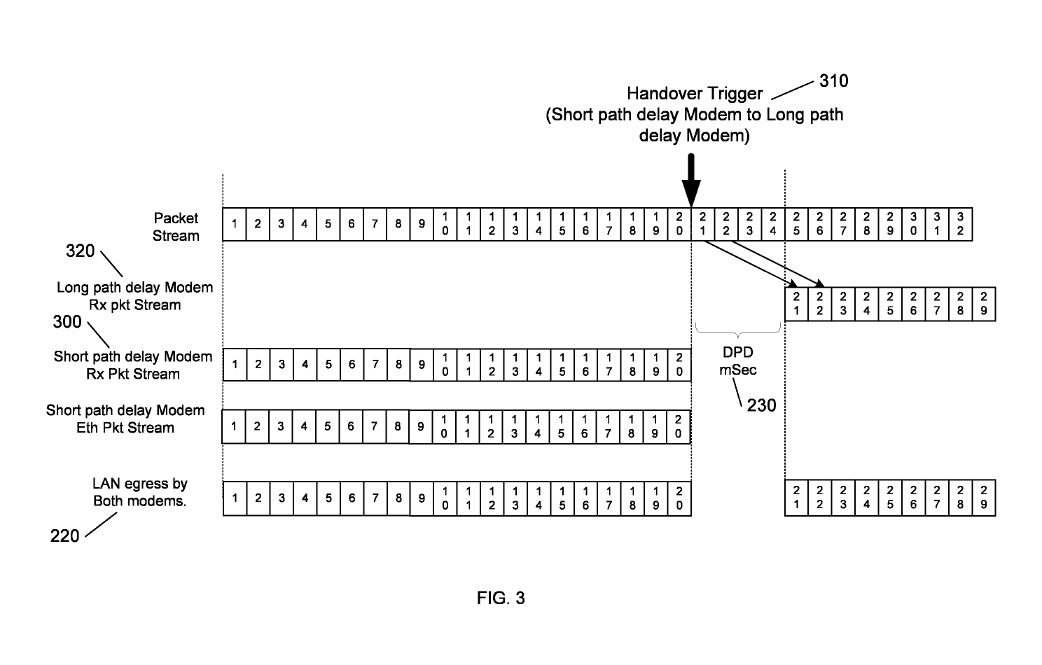

An example of the opposite situation in which data traffic from a handover gateway station 110 to a remote station 125 during a switch from a short-path delay satellite to a long-path delay satellite is depicted in FIG. 3.

As shown, just before the antenna handover trigger, the short-path-delay modem is active 300, so it receives the packets from gateway and egresses to the LAN interface 220. Upon receiving the antenna handover trigger message 310, the receive path becomes inactive immediately. Also, just before the antenna handover is triggered, the long-path-delay modem is inactive 320, so it receives the data packets, but drops them at the modem and does not egress them to the LAN. Upon receiving the antenna handover trigger 310, the receive path becomes active immediately. At this point, since the long delay path is becoming activated, this modem has to wait for DPD amount of time 230 to get the next sequence packet egress by the short-path modem. Hence there is a no need for buffering received data packets during this time in this scenario.

Using the disclosed systems and methods, switching from short-path-delay to long-path-delay satellites, with data traffic receiving from gateway 110 to remote 125, requires no special handling. Since the remote station's long-delay-path transmit modem just became active, this modem has to wait DPD time 230 for packets to arrive. Just before the antenna handover trigger, the short-path-delay modem is active, so it transmits the packets from the remote to the gateway. Upon receiving the antenna handover trigger message 230, the transmit path becomes inactive, and hence no data packet is transmitted to the gateway 110 by the short-path-delay modem. Also, just before the antenna handover trigger, the long-path-delay modem is inactive and not transmitting any packets. Upon receiving the antenna handover trigger, the transmit path becomes active immediately.

In some implementations of the disclosed system and method, two transmitters and two receivers may be used at the remote location, and one transmitter and two receivers at the Gateway location as shown in the example of FIG. 1. This can be implemented using commercial off the shelf (COTS) modem hardware with a software upgrade which is advantageous because no custom-built hardware is required to make this implementation operational.

In some implementations, both the receivers at the remote station are physically isolated boxes. Thus, when the handover signal arrives, both modems are processed independently which may have some jitter with respect to each other. Due to this processing jitter, packet drops or duplicates might be experienced in packets received from the gateway 110 to the remote 125. So in order to mitigate this, the gateway 110 transmits a synchronizing packet called a Handover Synchronization Packet (HSP) as shown in FIG. 4B. Since the gateway 110 has a single transmitter, the same HSP 500 will be received in a same order by the both the receivers at the remote 125. In this instance, both receivers now can synchronize the trigger. For example, upon receiving the HSP packet, the active modem will become the inactive modem and inactive modem will become active modem.

In order to avoid HSP packets 500 being received at the remote in the processing jitter period, the gateway 110 may trigger this message upon receiving a Doppler Delay Synchronization (DDS) message 510. Since the HSP packet 500 is critical to switching, the gateway 110 transmits many HSP packets 500 with sequence number built in to across many FEC blocks to make sure that in at least one HSP packet 500 is received. This implementation also supports the time out mechanism to change the state in the absence of the HSP packet 500.

In an implementation where the system cannot wait for more than propagation delay, the receiving modems may trigger on a hardware signal built into the jitter to minimize the duplicates. An example of a packet synchronization scheme that works with this implementation is depicted in the example discussed above in FIG. 2. Examples of HSP packet initiation processes are depicted in FIGS. 4A-B.

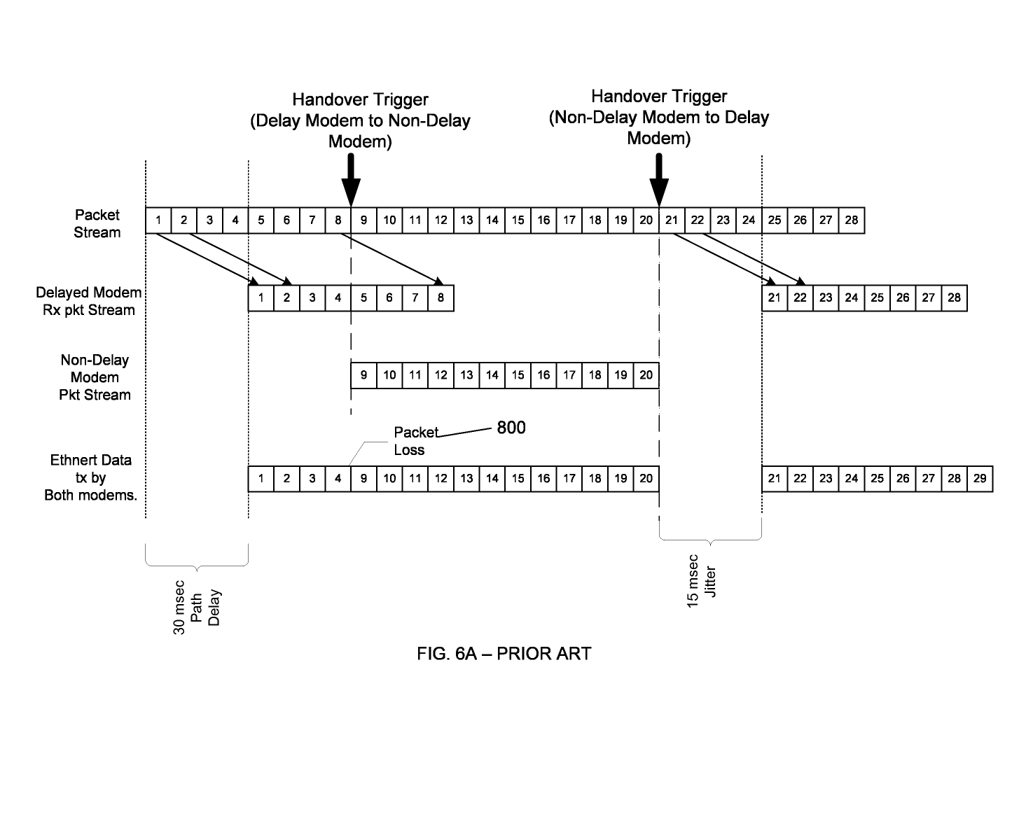

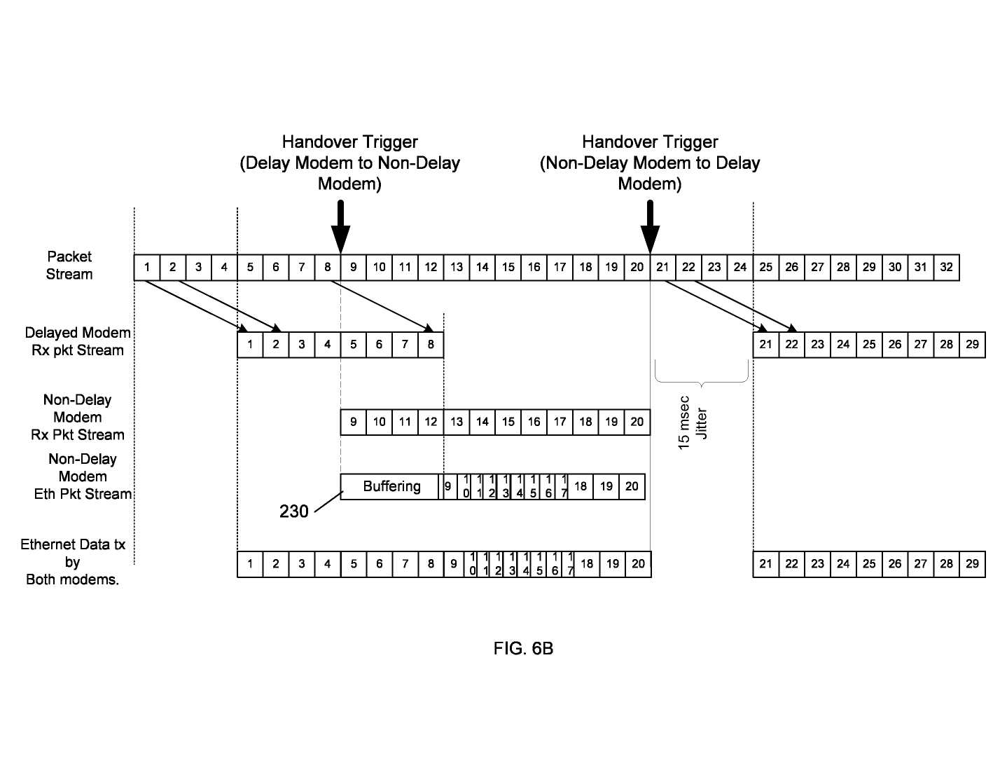

While a detailed discussion has been provided as it relates to implementations of the disclosed system and methods being used in situation in which antenna handover occurs between non-geostationary repeating relays, it is also contemplated that such implementations may be utilized for antenna handovers between delay and non-delay modems. FIG. 6A depicts an example of the prior art situation in which packet loss 800 occurs during the conventional methods used for such handover between repeating relays of varying levels of delay. As shown in FIG. 6B, however, in response to the handover trigger packet being received during the handover from the delay modem to the non-delay modem, buffering occurs for the delay duration as indicated by the delay indication packet 600 which is depicted in FIG. 4C.

It is also contemplated that one or more gateway or repeating relay stations may utilize redundancy and as such, implementations of the disclosed systems and methods are intended to provide seamless antenna handover without any packet loss or duplicate packets when redundant configurations are utilized.

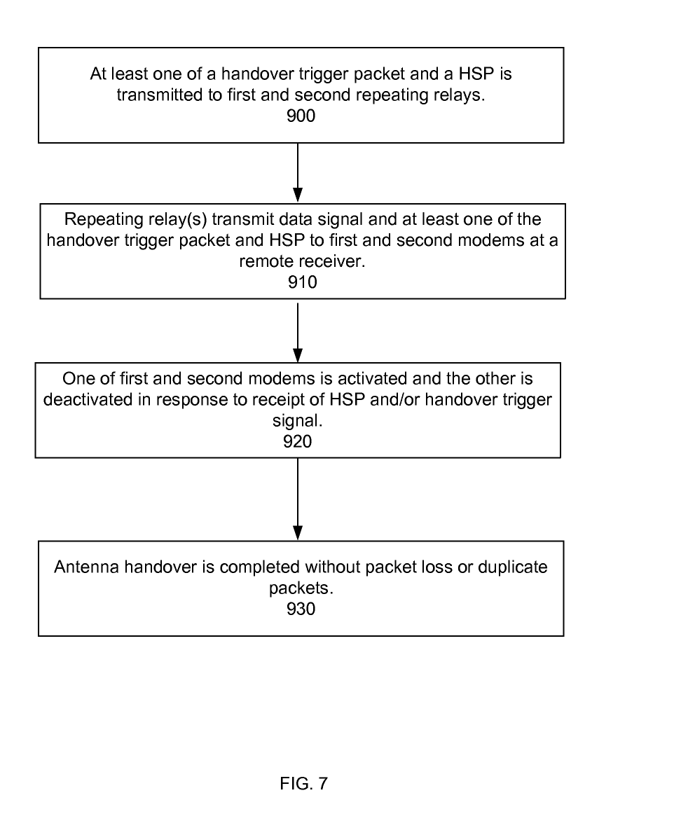

FIG. 7 provides a block diagram of an implementation of the disclosed methods which are intended to be utilized for effective antenna handovers between repeating relays having unequal path delays as well as with systems in which handovers occur between delayed and non-delayed modems. As shown, at least one of a handover trigger packet and a handover synchronization packet (HSP) may be transmitted to the two or more repeating relays 900. In some implementations, both the handover trigger packet and the HSP may be transmitted and in other implementations, only one or the other is transmitted. Depending upon which packet(s) are transmitted to the repeating relays, the at least one of the handover trigger packet and the HSP are received by the first and second modems and the remote receiver along with the data signal 910. In response to receiving the at least one of the handover trigger packet and the HSP with the data signal, the modem that was previously active becomes inactive and the previously inactive modem becomes active 920 to complete the antenna handover without packet loss or duplication 930.

In places where the description above refers to particular implementations of seamless antenna handover systems and related methods for non-geosynchronous satellites, it should be readily apparent that a number of modifications may be made without departing from the spirit thereof and that these implementations may be applied to other system and method implementations.

We claim:

1. A method of seamless antenna handover comprising:
transmitting at least one of a handover trigger packet and a handover synchronization packet (HSP) by a transmitter to a first and a second repeating relay, the first repeating relay configured to transmit a data signal to a first modem at a remote receiver and the second repeating relay configured to transmit the data signal to a second modem at the remote receiver;
receiving, by the first and second modems at the remote receiver, the data signal and the at least one of the handover trigger packet and the HSP from the first and second repeating relays, respectively; and
activating one of the first and second modems and deactivating the other of the first and second modems in response to receiving the at least one of the handover trigger packet and the HSP.

2. The method of claim 1, wherein a path delay between the transmitter and the remote receiver is shorter for the first repeating relay than the path delay between the transmitter and the remote receiver for the second repeating relay.

3. The method of claim 2, wherein the HSP is received during a buffering period during the antenna handover.

4. The method of claim 1, wherein the transmitter transmits the HSP across a plurality of FEC blocks.

5. The method of claim 2, further comprising transmitting a Doppler Delay Packet (DDP) by the activated modem at the remote receiver to the transmitter.

6. The method of claim 2, wherein the second modem waits for a Doppler Packet Delay (DPD) duration prior to egressing data to a local area network (LAN) when the antenna handover is from the first repeating relay to the second repeating relay.

7. The method of claim 5, wherein the transmitter buffers transmitted data for the duration of the Doppler Packet Delay (DPD) in response to receiving the DDP.

8. The method of claim 7, wherein after the data is no longer buffered by the transmitter, the first modem egresses the received data to a local area network (LAN).

9. The method of claim 1, wherein the antenna handover occurs without any duplicate data packets being egressed to a LAN by either of the first and second modems.

10. The method of claim 1, wherein the antenna handover occurs without any data packets being received out of sequence or dropped.

11. The method of claim 1, wherein the transmitter comprises a first modem configured to transmit and receive a data signal and a second modem configured to receive a data signal.

12. A system for seamless antenna handover comprising:
a transmitter configured to transmit at least one of a handover trigger packet and a handover synchronization packet (HSP) to a first and a second repeating relay; and
a remote receiver comprising:
a first modem configured to receive a data signal transmitted by the first repeating relay; and
a second modem configured to receive the data signal transmitted by the second repeating relay, wherein the first and second modems are further configured to:
receive the at least one of the handover trigger packet and the HSP from the first and second repeating relays, respectively; and
activate one of the first and second modems and deactivate the other of the first and second modems in response to receiving the at least one of the handover trigger packet and the HSP.

13. The system of claim 12, wherein a path delay between the transmitter and the remote receiver is shorter for the first repeating relay than the path delay between the transmitter and the remote receiver for the second repeating relay.

14. The system of claim 13, wherein the HSP is received during a buffering period during the antenna handover.

15. The system of claim 12, wherein the transmitter is further configured to transmit the HSP across a plurality of FEC blocks.

16. The system of claim 13, wherein the activated modem of the remote receiver is further configured to transmit a Doppler Delay Packet (DDP) to the transmitter.

17. The system of claim 13, wherein the second modem of the remote receiver is configured to wait for a Doppler Packet Delay (DPD) duration prior to egressing data to a local area network (LAN) when the antenna handover is from the first repeating relay to the second repeating relay.

18. The system of claim 16, wherein the transmitter is further configured to buffer transmitted data for the duration of the Doppler Packet Delay (DPD) in response to receiving the DDP.

19. The system of claim 18, wherein the first modem of the remote receiver is further configured to egress the received data to a local area network (LAN) after the data is no longer buffered by the transmitter.

20. The system of claim 12, wherein the antenna handover occurs without any duplicate data packets being egressed to a LAN by either of the first and second modems.

21. The system of claim 12, wherein the antenna handover occurs without any data packets being received out of sequence or dropped.

22. The system of claim 12, wherein the transmitter comprises a first modem configured to transmit and receive a data signal and a second modem configured to receive a data signal.
